(19) United States
(12) Patent Application Publication
(10) Pub. No.: US 2019/0019516 A1
(43) Pub. Date: Jan. 17, 2019

(54) SPEECH RECOGNITION USER MACROS FOR IMPROVING VEHICLE GRAMMARS

(71) Applicant: FORD GLOBAL TECHNOLOGIES, LLC, Dearborn, MI (US)

(72) Inventors: Patrick Lawrence Jackson VAN HOECKE, Dearborn, MI (US); Perry Robinson MacNEILLE, Lathrup Village, MI (US); Omar MAKKE, Lyon Township, MI (US); Oleg Yurievitch GUSIKHIN, Commerce Township, MI (US)

(21) Appl. No.: 15/649,740

(22) Filed: Jul. 14, 2017

(51) Int. Cl. G10L 15/26; B60R 16/037; G10L 15/22; G10L 25/78

(52) U.S. Cl. CPC G10L 15/265; G10L 25/78; G10L 15/22; B60R 16/0373

(57) ABSTRACT

A custom grammar is received by a telematics server from a vehicle including custom learned commands for a standard grammar. A plurality of custom grammars including the custom grammar are analyzed for consistent additions to the custom learned commands. Any consistent additions are added to a new command set. The new command set is incorporated into an updated version of the standard grammar. The updated standard grammar is sent to the vehicle.

### TECHNICAL FIELD

Aspects of the disclosure generally relate to using speech recognition user macros to improve vehicle speech recognition command sets.

### BACKGROUND

Vehicle computing platforms frequently come equipped with voice recognition interfaces. Such interfaces allow a driver to perform hands-free interactions with the vehicle, freeing the driver to focus maximum attention on the road. If the system is unable to recognize the driver's commands, the driver may manually correct the input to the system through a button or touchscreen interface, potentially causing the driver to be distracted and lose focus on the road.

Voice recognition is typically a probabilistic effort whereby input speech is compared against a grammar for matches. High quality matches may result in the system identifying the requested services, while low quality matches may cause voice commands to be rejected or misinterpreted. In general, vehicles may use recognition systems at least initially tuned to provide good results on average, resulting in positive experiences for the maximum number of new users. If a user has an accent or unusual mannerisms, however, match quality may be reduced. Moreover, as voice command input to a vehicle may be relatively infrequent, it may take a significant time for a vehicle to learn a user's speech patterns.

Currently voice recognition system can feel limited at times, as many functions may be unavailable to users. Moreover, functions that are available may be difficult to tailor to a user's specific preferences. Yet further, after a model launch, it may be difficult to update the available commands of a vehicle to be consistent with future commands sets. This can lead to a product that feels out of date.

### SUMMARY

A system includes a telematics server programmed to receive a custom grammar from a vehicle including custom learned commands for a standard grammar, load the standard grammar and corresponding custom grammars, analyze the custom grammars for consistent additions, add the consistent additions to a new command set, incorporate the new command set into an updated version of the standard grammar, and send the updated standard grammar to the vehicle.

A vehicle includes a memory storing a custom grammar and a standard grammar. The vehicle further includes a processor programmed to save commands to a custom grammar, each command including a set of monitored actions and voice input indicating a name to trigger the command, send the custom grammar to a remote server, and receive from the remote server an updated standard grammar including consistent additions of commands from plurality of custom grammars including the custom grammar.

A method includes generating, from a standard grammar of standard commands and a plurality of custom grammars each received over a wide-area network from one of a plurality of respective vehicles utilizing the standard grammar, an updated standard grammar including the standard commands and identified commands in the plurality of the custom grammars having a same name and at least a subset of overlapping features.

### BRIEF DESCRIPTION OF THE DRAWINGS

FIG. 1 illustrates an example diagram of a system configured to provide telematics services to a vehicle;

FIG. 2 illustrates an example diagram of a portion of the vehicle for adding a new command to the custom grammar;

FIG. 3 illustrates an example diagram of uploading of a custom grammar to the telematics server;

FIG. 4 illustrates an example diagram of creating a revised standard grammar from the standard grammar and one or more custom grammars;

FIG. 5 illustrates an example process for updating a custom grammar; and

FIG. 6 illustrates an example process for creating a revised standard grammar from the standard grammar and one or more custom grammars.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A voice recognition system of a vehicle may allow for users to customize function outputs with speech input. In an example, the system may allow a user to combine multiple existing functions into a single command that performs the multiple functions. These user-created commands may be provided to a remote server for analysis to allow for improvement of the existing function set. The remote server may analyze these user-created commands to identify commonly-made customizations. These common customizations may be implemented in future versions of the function set to improve the native functionality of the voice recognition system. Further aspects of the disclosure are discussed in detail below.

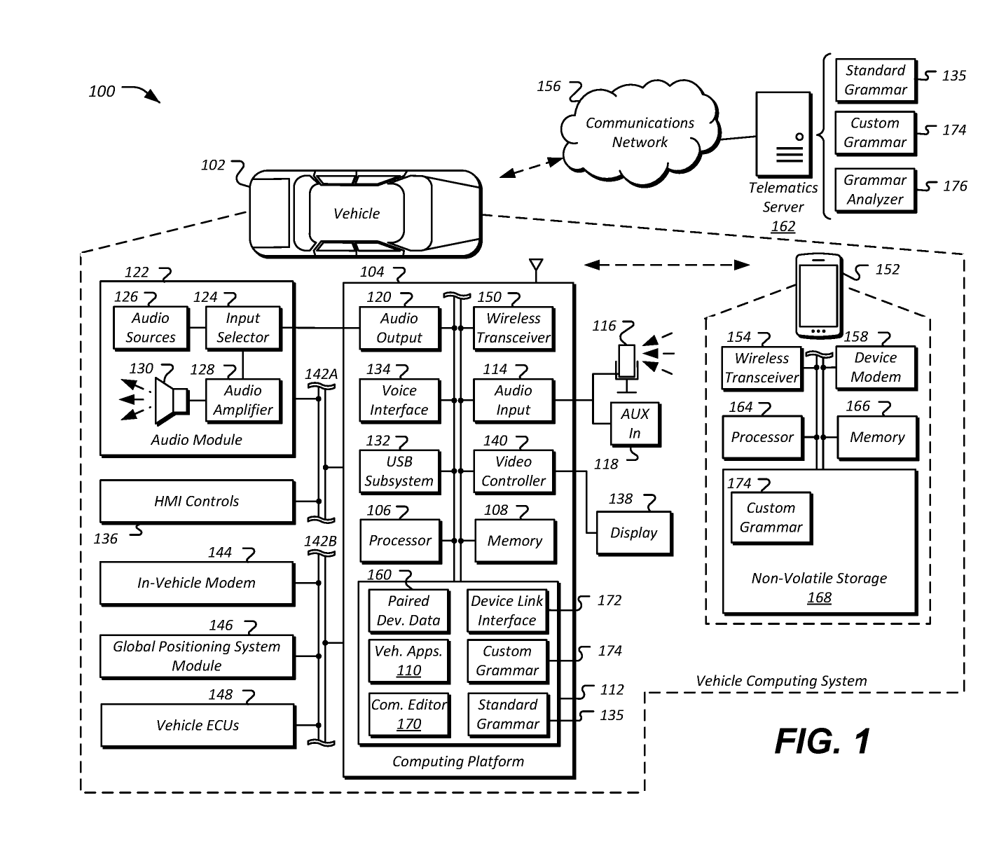

FIG. 1 illustrates an example diagram of a system 100 configured to provide telematics services to a vehicle 102. The vehicle 102 may include various types of passenger vehicle, such as crossover utility vehicle (CUV), sport utility vehicle (SUV), truck, recreational vehicle (RV), boat, plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, Mich. It should be noted that the illustrated system 100 is merely an example, and more, fewer, and/or differently located elements may be used.

The computing platform 104 may include one or more processors 106 configured to perform instructions, commands and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory medium (e.g., a tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a physical connection, such as an electrical wire or a fiber optic cable, or a wireless input, such as a BLUETOOTH audio connection. In some examples, the audio input 114 may be configured to provide audio processing capabilities, such as pre-amplification of low-level signals, and conversion of analog inputs into digital data for processing by the processor 106.

The computing platform 104 may also provide one or more audio outputs 120 to an input of an audio module 122 having audio playback functionality. In other examples, the computing platform 104 may provide the audio output to an occupant through use of one or more dedicated speakers (not illustrated). The audio module 122 may include an input selector 124 configured to provide audio content from a selected audio source 126 to an audio amplifier 128 for playback through vehicle speakers 130 or headphones (not illustrated). The audio sources 126 may include, as some examples, decoded amplitude modulated (AM) or frequency modulated (FM) radio signals, and audio signals from compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. The voice interface 134 may support speech recognition from audio received via the microphone 116 according to a standard grammar 135 describing available command functions, and voice prompt generation for output via the audio module 122. The voice interface 134 may utilize probabilistic voice recognition techniques using the standard grammar 176 in comparison to the input speech. In many cases, the voice interface 134 may include a standard user profile tuning for use by the voice recognition functions to allow the voice recognition to be tuned to provide good results on average, resulting in positive experiences for the maximum number of initial users. In some cases, the system may be configured to temporarily mute or otherwise override the audio source specified by the input selector 124 when an audio prompt is ready for presentation by the computing platform 104 and another audio source 126 is selected for playback.

The standard grammar 135 includes data to allow the voice interface 134 to match spoken input to words and phrases that are defined by rules in the standard grammar 135. The standard grammar 135 can be designed to recognize a predefined set of words or phrases. A more complex standard grammar 135 can be designed to recognize and organize semantic content from a variety of user utterances. In an example, the standard grammar 135 may include commands to initiate telematics functions of the vehicle 102, such as “call,” “directions,” or “set navigation destination.” In another example, the standard grammar 135 may include commands to control other functionality of the vehicle 102, such as “open windows,” “headlights on,” or “tune to radio preset three.”

The computing platform 104 may also receive input from human-machine interface (HMI) controls 136 configured to provide for occupant interaction with the vehicle 102. For instance, the computing platform 104 may interface with one or more buttons or other HMI controls configured to invoke functions on the computing platform 104 (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as a vehicle modem 144 (which may not be present in some configurations), a global positioning system (GPS) module 146 configured to provide current vehicle 102 location and heading information, and various vehicle ECUs 148 configured to corporate with the computing platform 104. As some non-limiting possibilities, the vehicle ECUs 148 may include a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); a radio transceiver module configured to communicate with key fobs or other local vehicle 102 devices; and a climate control management module configured to provide control and monitoring of heating and cooling system components (e.g., compressor clutch and blower fan control, temperature sensor information, etc.).

As shown, the audio module 122 and the HMI controls 136 may communicate with the computing platform 104 over a first in-vehicle network 142-A, and the vehicle modem 144, GPS module 146, and vehicle ECUs 148 may communicate with the computing platform 104 over a second in-vehicle network 142-B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

Responsive to receipt of voice input, the voice interface 134 may produce a short list of possible recognitions based on the standard grammar 135, as well as a confidence that each is the correct choice. If one of the items on the list has a relatively high confidence and the others are relatively low, the system may execute the high-confidence command or macro. If there is more than one high-confidence macro or command, the voice interface 134 may synthesize speech requesting clarification between the high-confidence commands, to which the user can reply. In another strategy, the voice interface 134 may cause the computing platform 104 to provide to a display 138 a prompt for a user to confirm which command to choose. In some examples, the voice interface 134 may receive user selection of the correct choice, and the voice interface 134 may learn from the clarification and retune its recognizer for better performance in the future. If none of the items are of high confidence, the voice interface 134 may request for the user to repeat the request.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, or other devices capable of communication with the computing platform 104. In many examples, the computing platform 104 may include a wireless transceiver 150 (e.g., a BLUETOOTH module, a ZIGBEE transceiver, a Wi-Fi transceiver, an IrDA transceiver, an RFID transceiver, etc.) configured to communicate with a compatible wireless transceiver 154 of the mobile device 152. Additionally or alternately, the computing platform 104 may communicate with the mobile device 152 over a wired connection, such as via a USB connection between the mobile device 152 and the USB subsystem 132. In some examples the mobile device 152 may be battery powered, while in other cases the mobile device 152 may receive at least a portion of its power from the vehicle 102 via the wired connection.

The communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, such that the computing platform 104 may automatically reconnected to the mobile devices 152 referenced in the paired device data 160 without user intervention.

When a mobile device 152 that supports network connectivity is paired with the computing platform 104, the mobile device 152 may allow the computing platform 104 to use the network connectivity of the device modem 158 to communicate over the communications network 156 with the remote telematics server 162 or other remote computing device. In one example, the computing platform 104 may utilize a data-over-voice plan or data plan of the mobile device 152 to communicate information between the computing platform 104 and the communications network 156. Additionally or alternately, the computing platform 104 may utilize the vehicle modem 144 to communicate information between the computing platform 104 and the communications network 156, without use of the communications facilities of the mobile device 152.

Similar to the computing platform 104, the mobile device 152 may include one or more processors 164 configured to execute instructions of mobile applications loaded to a memory 166 of the mobile device 152 from storage medium 168 of the mobile device 152. In some examples, the mobile applications may be configured to communicate with the computing platform 104 via the wireless transceiver 154 and with the remote telematics server 162 or other network services via the device modem 158. The computing platform 104 may also include a device link interface 172 to facilitate the integration of functionality of the mobile applications into the grammar of commands available via the voice interface 134. The device link interface 172 may also provide the mobile applications with access to vehicle information available to the computing platform 104 via the in-vehicle networks 142. An example of a device link interface 172 may be the SYNC APPLINK component of the SYNC system provided by the Ford Motor Company of Dearborn, Mich. Other examples of device link interfaces 172 may include MIRRORLINK, APPLE CARPLAY, and ANDROID AUTO.

In some instances, a user may desire to add new commands to the voice interface 134 that are not present in the standard grammar 135. For instance, the user may identify that the vehicle 102 has one or more available features that are not currently controlled by any commands in the standard grammar 135. In another example, the user may identify that while certain individual feature can be controlled, the standard grammar 135 fails to include a command that includes a combination of available features.

A command editor 170 may be an example of a vehicle application 110 installed to the storage 112 of the computing platform 104. The command editor 170 may be configured to allow the user to create a custom grammar 174 including commands for features that are not currently available in the standard grammar 135, or combinations of commands that are not available in the standard grammar 135.

A grammar analyzer 176 may be an example of an application installed to the telematics server 162. When executed by the telematics server 162, the grammar analyzer 176 analyzes the user-created commands in one or more customer grammars 174 to identify commonly-made customizations. These common customizations may be implemented in future versions of the standard grammar 135 to improve the native functionality of the voice interface 134.

Some automotive voice interfaces follow from traditional graphical user interface design. For instance, an example of a user attempting to route to a destination may include a scenario such as:
User: <push button> “Navigation” <release button>
System: “Navigation, what would you like to do?”
User: <push button> “Route” <release button>
System: Enter destination address, what country?
User <push button> “United States” <release button>
System: “What state?”
User: <push button> “Michigan” <release button>
. . .

To utilize such prompts requires user attention and draws cognitive load, as the user is required to remember his or her current location in a menu tree. However, by using custom grammar 174 commands or macros, the user can teach the system 100 to execute a sequence of steps, such as the sequence above with a single utterance. For example, if the key utterance is “Magic Carpet Ride” the same sequence may be simplified to the following:
User: <press button> “Magic Carpet Ride” <release button>
System: “Displaying route to Acme Warehouse, will begin navigation”

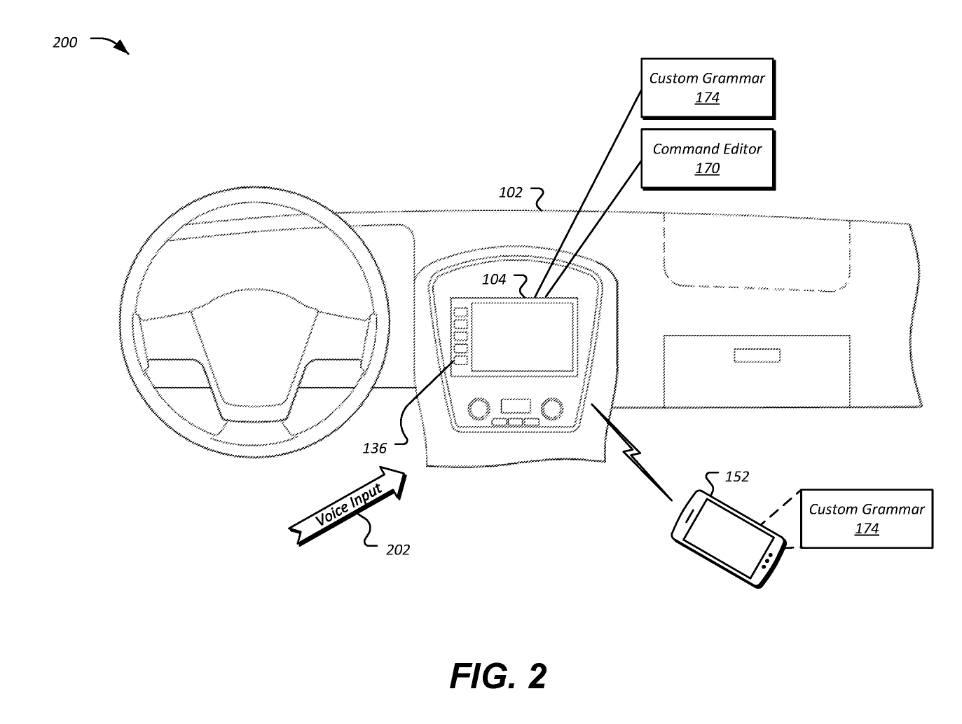

FIG. 2 illustrates an example diagram 200 of a portion of the vehicle 102 for adding a new command to the custom grammar 174. In an example, the user may select one of the HMI controls 136 of the computing platform 104 for adding a new command. Responsive to selection of the add new command function, the computing platform 104 activates the command editor 170 to listen for command input to the HMI controls 136. For instance, command input via the HMI controls 136 may be monitored by the command editor 170 using the connection of the computing platform 104 to the one or more vehicle buses 142. Continuing with the example, the user may again select the one of the HMI controls 136 to conclude learning of the command by the command editor 170, or may select a different command to conclude the learning of the command.

In some examples, during or at the conclusion of the recording, the command editor 170 may display a listing of the recorded inputs. In some examples, the user interface may be made to the display 138 of the computing platform 104, while in other cases, the user interface may be displayed to the user's mobile device 152. This display of recorded inputs identifies the operations performed by the use, such as what the user has selected or turned on or off during the duration of the recording. Using the displayed listing, the user can could select which of the recorded items were intended for this macro. For instance, one or more extraneous actions may have been recorded that were not intended to be included in the macro. If so, these actions could be deselected by the user using the command editor 170 display.

The user may further provide voice input 202 to the command editor 170. For instance, the voice input 202 may be received by the microphone 116, processed by the voice interface 134 into text, and provided to the command editor 170. In some examples, text may be encoded in a phonetic alphabet such as the International Phonetic Alphabet (IPA). Using a phonetic alphabet reduces the amount of processing and ambiguity of the recognition by the computing platform 104. The command editor 170 may thereby associate the voice input 202 with the command input and save the combination as a new command into the custom grammar 174. Once added to the custom grammar 174, the user may speak the voice input 202 to the computing platform 104 to cause the computing platform 104 to perform the recorded command input. Accordingly, the user may utilize the command editor 170 to add additional voice commands to the voice interface 134.

In an example of a new command, the user may provide command inputs that places the user's saved “home” address into a navigation system of the vehicle 102 as a destination, and begins to route the user to that destination. The user may associate this new command with the name or phrase “take me home.” In another example of a new command, the user may provide command inputs to switch the input selector 124 to a CD audio source 126, select a loud volume level for the audio amplifier 128, and select to play a third track of a CD. The user may associate this new command with the name or phrase “play my favorite song.” In yet a further example of a new command, the user may provide command inputs to adjust vehicle climate settings, switch on satellite radio, and open a sunroof. The user may associate this new command with the name or phrase “Sally's user settings.” It should be noted that more than one utterance can be programmed to start a macro or command. For example, different users may prefer different speech patterns to execute the same macro or command.

The custom grammar 174 may be stored to the storage 112 of the computing platform 104. Additionally or alternately, the custom grammar 174 may be stored to the storage 168 of a mobile device 152 in communication with the device link interface 172 of the computing platform 104. By storing the custom grammar 174 to the mobile device 152, the user may be able to utilize the custom commands across vehicles 102. For instance, responsive to connection of the mobile device 152 to the computing platform 104, the command editor 170 may cause the computing platform 104 to access and import any custom grammar 174 commands stored on the mobile device 152 to the computing platform 104.

It should be noted that custom grammars 174 can be made by application developers instead of or in addition to users of the vehicles 102 themselves. For example, to start app XYZ an application developer may recognize that the user of the vehicle 102 performs the following steps: (i) go to home screen; (ii) press apps button; (iii) press connect mobile apps; and (iv) press XYZ app button. These steps can be compiled by the application developer into a single macro command that is programmed to run on an utterance, e.g., “run XYZ,” or with a button push associated with the macro. The app developer may then submit using his or her vehicle 102 (or via another mechanism) the custom grammars 174 for consideration.

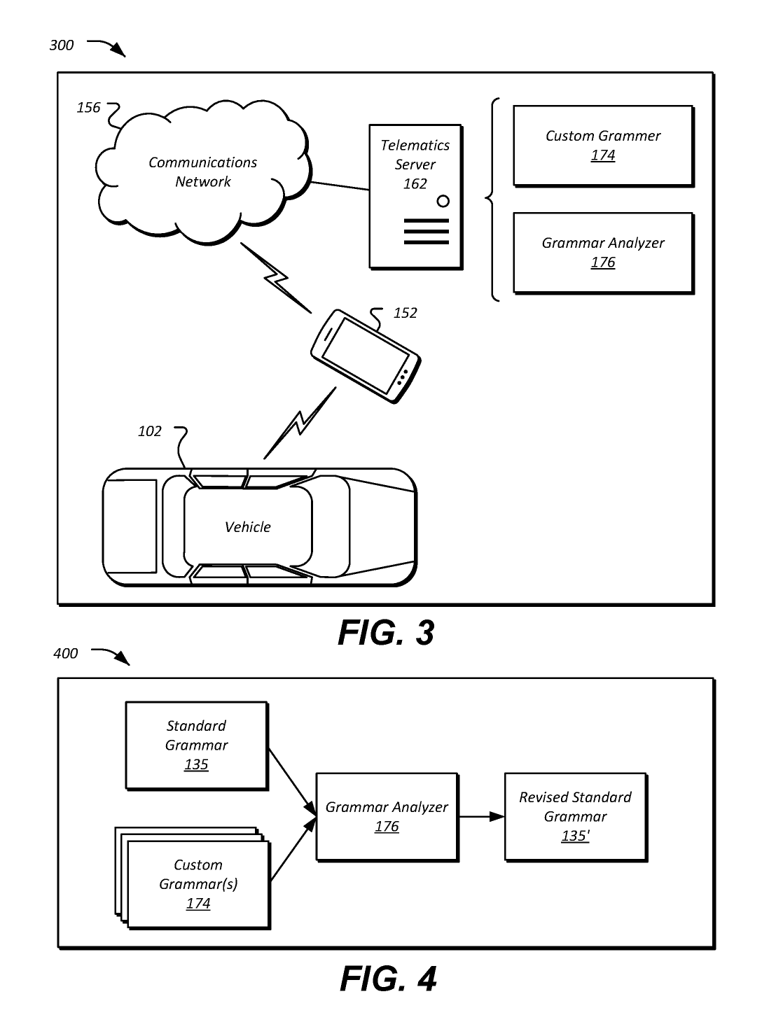

FIG. 3 illustrates an example diagram 300 of uploading of the custom grammar 174 to the telematics server 162. In an example, the computing platform 104 may utilize the connection services of the mobile device 152 to transmit the custom grammar 174 over the communications network 156 to the telematics server 162. In another example, the computing platform 104 may utilize an embedded modem (not shown) to transmit the custom grammar 174 over the communications network 156 to the telematics server 162.

Transfer of the custom grammar 174 to the telematics server 162 may be triggered based on various criteria. In an example, the user may select to upload the custom grammar 174. In another example, the computing platform 104 may periodically offload the custom grammar 174, e.g., after one or more of a predefined period of time (e.g., monthly), a predefined number of key cycles of the vehicle 102 (e.g., thirty), or a predefined number of miles driven by the vehicle 102 (e.g., one thousand).

FIG. 4 illustrates an example diagram 400 of creating a revised standard grammar 135′ from the standard grammar 135 and one or more custom grammars 174. In an example, the telematics server 162 receives custom grammars 174 from a plurality of vehicles 102 and vehicle users. Using this plurality of custom grammars 174, the grammar analyzer 176 analyzes the new commands to identify additional commands that are not included in the standard grammar 135 for inclusion in the revised standard grammar 135′.

In an example, the grammar analyzer 176 identifies sequences of features that are common to commands in more than one of the custom grammars 174. For instance, if the grammar analyzer 176 identifies commands in multiple custom grammars 174 that perform the same set of features (e.g., roll down all windows), then the grammar analyzer 176 may identify this set of commands as being a candidate for inclusion in a revised standard grammar 135′.

In another example, the grammar analyzer 176 identifies names of commands that are common to commands in more than one of the custom grammars 174. For instance, if the grammar analyzer 176 identified commands in multiple custom grammars 174 that have the same name (and that perform the same or at least a subset of the same features), then the grammar analyzer 176 may identify this set of commands as being a candidate for inclusion in a revised standard grammar 135′.

In yet a further example, the grammar analyzer 176 may consider near-matches of command names and/or command sequences. In an example, the grammar analyzer 176 may consider synonyms of command names together (e.g., close windows, shut windows, etc.) in the consideration of names of commands. To do so, the grammar analyzer 176 may maintain or access a thesaurus of words to identify which words or phrases should be considered together. In another example, the grammar analyzer 176 may consider near-match command sequences having the same commands but in a different ordering (e.g., close driver window then close passenger window, and close passenger window then close driver window).

Regardless of approach, the additional commands that are not included in the standard grammar 135 may accordingly be added by the grammar analyzer 176 to the standard grammar 135 to create the standard grammar 135′. The telematics server 162 then serve the standard grammar 135′ as a software update to the vehicles 102 to allow the vehicles 102 to automatically utilize the additional commands.

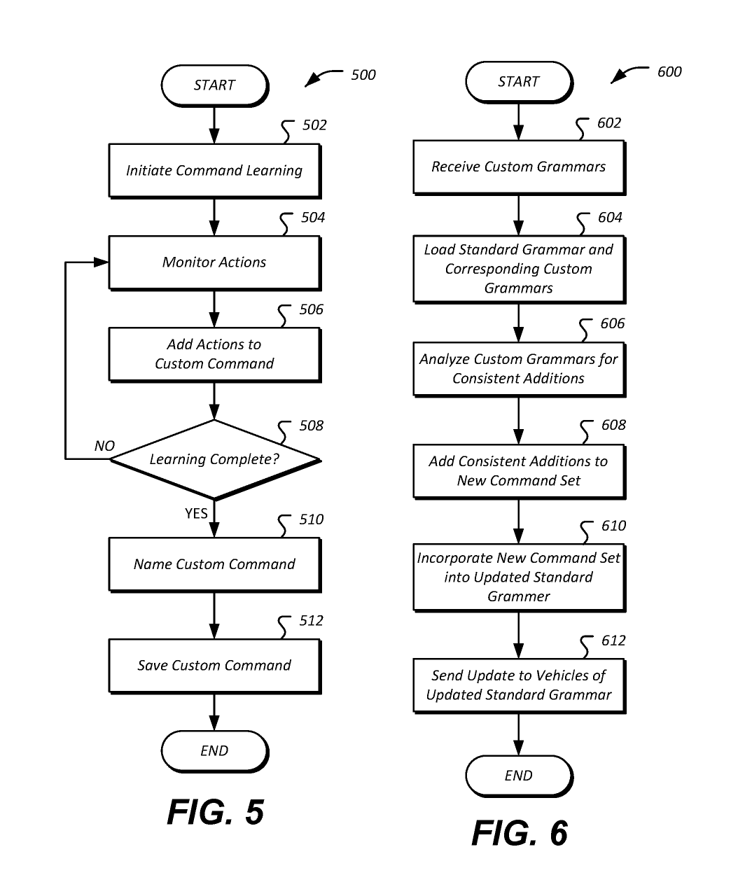

FIG. 5 illustrates an example process 500 for updating a custom grammar 174. In an example, the process 500 may be performed by the command editor 170 executed by the computing platform 104 of the vehicle 102.

At operation 502, the computing platform 104 initiates command learning. In an example, the user may select one of the HMI controls 136 of the computing platform 104 for adding a new command. Responsive to selection of the add new command function, the computing platform 104 activates the command editor 170 to listen for command input to the HMI controls 136.

At 504, the computing platform 104 monitors actions. In an example, the command editor 170 of the computing platform 104 monitors command input via the HMI controls 136 using the connection of the computing platform 104 to the one or more vehicle buses 142. In another example, the command editor 170 monitors spoken command input via the voice input 202.

The computing platform 104 adds actions to a custom command at 506. In an example, the command editor 170 adds the monitored actions to a new custom command.

At operation 508, the computing platform 104 determined whether learning of the command is complete. In an example, the command editor 170 may monitor for an HMI action indicative of conclusion of learning of the custom command. In another example, after each action input, the command editor 170 may set a countdown timer such that when the countdown timer period elapses with no further action input, command learning is concluded. If learning of the command is complete, control passes to operation 510. Otherwise, control returns to operation 504 to continue the monitoring.

At 510, the computing platform 104 names the custom command. In an example, the command editor 170 may receive voice input 202 processed by the voice interface 134 into text. This received name or phrase may be used as the identifier for the custom command, such that speaking the name of the custom command executes the custom command, consistent with voice activation of the commands of the standard grammar 135.

The computing platform 104 saves the custom command at 512. In an example, the command editor 170 saves the custom command into a custom grammar 174 maintained in the storage 112 of the computing platform 104. In another example, the custom grammar 174 is additionally or alternately maintained on the mobile device 152 paired to and connected to the vehicle 102. After operation 512, the process 500 ends.

FIG. 6 illustrates an example process 600 for creating a revised standard grammar 135′ from the standard grammar 135 and one or more custom grammars 174. In an example, the process 600 may be performed by the grammar analyzer 176 of the telematics server 162.

At operation 602, the telematics server 162 receives one or more custom grammars 174. In an example, the telematics server 162 may receive custom grammars 174 from one or more vehicles 102. In some examples, the custom grammars 174 may be received from computing platforms 104 of the vehicles 102. In other examples, the custom grammars 174 may be received from mobile devices 152. Receipt of the custom grammar 174 to the telematics server 162 may be triggered based on various criteria. In an example, a user may select to upload the custom grammar 174, for example using the HMI of the vehicle 102 or of the mobile device 152. In another example, the computing platform 104 may periodically offload the custom grammar 174, e.g., after one or more of a predefined period of time (e.g., monthly), a predefined number of key cycles of the vehicle 102 (e.g., thirty), or a predefined number of miles driven by the vehicle 102 (e.g., one thousand). The custom grammars 174 may be stored to a storage of the telematics server 162 for further processing.

At 604, the telematics server 162 loads a standard grammar 135 and one or more corresponding custom grammars 174. In an example, the grammar analyzer 176 loads a standard grammar 135 of a particular version. Each of the custom grammars 174 may indicate a version of a standard grammar 135 that the custom grammars 174 is designed to augment. Accordingly, the grammar analyzer 176 further loads the custom grammars 174 corresponding to the version number of the loaded standard grammar 135.

The telematics server 162 analyzes the custom grammars 174 for consistent additions at 606. In an example, the grammar analyzer 176 identifies sequences of commands that are common to commands in more than one of the custom grammars 174. In another example, the grammar analyzer 176 identifies names of commands that are common to commands in more than one of the custom grammars 174. In yet a further example, the grammar analyzer 176 may consider near-matches of command names and/or command sequences.

At 608, the telematics server 162 adds the consistent additions to a new command set. In an example, if the grammar analyzer 176 locates any consistent additions, those additions are added to a new command set of commands to be included in a future version of the standard grammar 135.

At operation 610, the telematics server 162 incorporates the new command set into the standard grammar 135 to create an updated standard grammar 135′. In an example, the grammar analyzer 176 adds the new command set to the standard grammar 135 and increments the version of the standard grammar 135 to generate a resultant standard grammar 135′.

At 612, the telematics server 162 sends an update to the vehicle 102 including the updated standard grammar 135′. In an example, the telematics server 162 serves the standard grammar 135′ as a software update to the vehicles 102 to allow the vehicles 102 to automatically utilize the additional commands. After operation 612, the process 600 ends.

Computing devices described herein, such as the computing platform 104, mobile device 152, and telematics server 162, generally include computer-executable instructions where the instructions may be executable by one or more computing devices such as those listed above. Computer-executable instructions, such as those of the command editor 170 of the grammar analyzer 176, may be compiled or interpreted from computer programs created using a variety of programming languages and/or technologies, including, without limitation, and either alone or in combination, Java™, C, C++, C#, Visual Basic, JavaScript, Python, JavaScript, Perl, PL/SQL, Prolog, LISP, Corelet, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a telematics server programmed to
receive a custom grammar from a vehicle including custom learned commands for a standard grammar,
analyze a plurality of custom grammars including the custom grammar for consistent additions to the custom learned commands,
add the consistent additions to a new command set,
incorporate the new command set into an updated version of a standard grammar, and
send the updated standard grammar to the vehicle.

2. The system of claim 1, wherein the custom grammars indicate a version of a standard grammar that the custom grammars are designed to augment and the telematics server is further programmed to load the custom grammars by querying a storage for custom grammars indicating the version of the standard grammar.

3. The system of claim 1, wherein the telematics server is further programmed to:
identify sequences of features that are common to commands in more than one of the custom grammars; and
include the sequence of features as a command in the new command set.

4. The system of claim 1, wherein the telematics server is further programmed to:
identify commands in more than one of the custom grammars that have a same name and at least a subset of overlapping features; and
include a command with the name in the new command set.

5. The system of claim 4, wherein the telematics server is further programmed to consider synonyms of the name as having the same name.

6. The system of claim 1, wherein the telematics server is further programmed to:
identify a plurality of vehicles at a version of the standard grammar; and
indicate to each of the plurality of vehicles that the updated standard grammar is available for download.

7. The system of claim 1, wherein each command of the custom learned commands includes a name to be spoken to invoke the respective command as well as one or more features of the vehicle to be invoked responsive to invocation of the respective command.

8. A vehicle comprising:
a memory storing a custom grammar and a standard grammar; and
a processor programmed to
save commands to a custom grammar, each command including a set of monitored actions and voice input indicating a name to trigger the command,
send the custom grammar to a remote server, and
receive from the remote server an updated standard grammar including consistent additions of commands from a plurality of custom grammars including the custom grammar.

9. The vehicle of claim 8, wherein the processor is further programmed to monitor for actions to add to a new command responsive to initiation of command learning responsive initiated by input to a vehicle human machine interface (HMI) control.

10. The vehicle of claim 9, wherein the processor is further programmed to conclude learning of the command responsive to a second input to the vehicle human machine interface (HMI) control.

11. The vehicle of claim 8, wherein the processor is further programmed to set a countdown timer such that when a countdown timer period elapses with no further action input, command learning is concluded.

12. The vehicle of claim 8, wherein the processor is further programmed to send the custom grammar to the remote server periodically according to one or more of a predefined period of time, a predefined number of key cycles of the vehicle, or a predefined number of miles driven by the vehicle.

13. A method comprising:
generating, from a standard grammar of standard commands and a plurality of custom grammars each received over a wide-area network from one of a plurality of respective vehicles utilizing the standard grammar, an updated standard grammar including the standard commands and identified commands in the plurality of the custom grammars having a same name and at least a subset of overlapping features.

14. The method of claim 13, further comprising:
identifying sequences of features that are common to commands in more than one of the custom grammars; and
including the sequence of features as a command in the updated standard grammar.

15. The method of claim 13, further comprising:
identifying commands in more than one of the custom grammars that have a same name and at least a subset of overlapping features; and
including a command with the name in the updated standard grammar.

16. The method of claim 13, further comprising considering synonyms of the name as having the same name.
